(19) United States
(12) Patent Application Publication
(10) Pub. No.: US 2026/0355842 A1
(43) Pub. Date: Nov. 12, 2026

(54) HEAT EXCHANGER MODULE FOR ARRANGING ON A SOLDERING SYSTEM AND HAVING A NONWOVEN FILTER, AND SOLDERING SYSTEM HAVING A HEAT EXCHANGER MODULE

(71) Applicant: ERSA GMBH, Wertheim (DE)

(72) Inventors: Meinrad Eckert, Freudenberg (DE); Jürgen Friedrich, Wertheim (DE); Wolfram Hübsch, Frankfurt (DE)

(21) Appl. No.: 19/124,758

(22) PCT Filed: Oct. 5, 2023
(86) PCT No.: PCT/EP2023/077585

§ 371 Date: Apr. 25, 2025

(30) Foreign Application Priority Data
Nov. 3, 2022 (DE) 10 2022 129 100.6

(51) Int. Cl. B23K 3/08; B23K 3/04

(52) U.S. Cl. CPC B23K 3/085; B23K 3/04

(57) ABSTRACT

Heat exchanger module (22) for removably arranging on a soldering system (10), in particular a reflow soldering system comprising a nonwoven filter (70), and soldering system.

The invention relates to a heat exchanger module for arranging on a soldering system, in particular on a reflow soldering system. The heat exchanger module has an inlet for the inlet of process gas coming from the soldering system, a transfer chamber in which a heat exchanger element, through which a coolant can flow, is provided, and an outlet for discharging process gas from the heat exchanger module into the soldering system. The heat exchanger element has an upper surface against which the process gas can flow. During operation, the arrangement is such that the process gas is conducted from the inlet through the transfer chamber and, for cooling the process gas, through the heat exchanger element provided therein, to the outlet.

Such heat exchanger modules are installed by the applicant for example in the Hotflow 4 reflow soldering systems available at the time of filing. The heat exchanger modules serve to cool the heated process gas in the respective process zone, in particular in the cooling zone. The process gas contains both particles and vaporized flux, as well as soldering fumes, which condense when the process gas cools down. It has been shown that condensate and deposits form on the surface of the heat exchangers. This causes the heat exchanger elements to become clogged after a relatively short period of time, which makes it necessary to clean or replace the heat exchanger elements.

The object of the present invention is that of preventing clogging of the heat exchanger elements, in particular with particles and condensate, as far as possible, for a longer period of time.

This object is achieved by a heat exchanger module having the features of claim 1 and by a soldering system having the features of claim 10.

Consequently, it is provided in particular that the heat exchanger module has a first receiving element for a roll of nonwoven filter and a second receiving element for receiving nonwoven filter that is unwound from the roll, the two receiving elements being arranged such that, when nonwoven filter is present on the receiving elements, the nonwoven filter is guided from the first receiving element to the second receiving element over the top of the heat exchanger element. This ensures that the process gas passes through the nonwoven filter immediately before entering the heat exchanger element. Particles contained in the process gas and any condensate that forms can therefore be absorbed by the nonwoven filter. By providing the receiving elements and the roll of nonwoven filter, the roll of nonwoven filter can be unwound before the nonwoven filter is clogged with particles and condensate, so that a fresh, unclogged region of the nonwoven filter is guided over the top of the heat exchanger element. The roll of nonwoven filter can be unwound in particular while the soldering system is in operation; the soldering process is therefore not interrupted or negatively influenced in any other way.

Furthermore, it is advantageous if a drive is provided for rotationally driving the at least one receiving element. Preferably, the receiving element on which the nonwoven filter is wound is the one that is driven. In this case, the nonwoven filter can be moved over the top of the heat exchanger element by means of the drive. In this case, the driving can either take place continuously or when a clogged nonwoven filter is expected or when the nonwoven filter is clogged.

In order to determine the state of the nonwoven filter, it is advantageous if a sensor unit is provided for providing a sensor signal, the sensor signal representing a degree of contamination and/or a flow resistance of the nonwoven filter region guided over the upper side of the heat exchanger element. The sensor unit can in particular be an optical sensor unit which detects a degree of contamination, for example by means of image comparison and image recognition. It is also conceivable that the sensor unit determines the flow resistance of the nonwoven filter and that the degree of contamination of the nonwoven filter is determined from the changing flow resistance when the nonwoven filter is clogged. By providing the sensor signal, it can be detected whether the nonwoven filter present on the top of the heat exchanger element is so dirty and clogged that moving the nonwoven filter and in particular controlling the drive for replacing the nonwoven filter region present on the top of the heat exchanger is necessary or not.

Furthermore, it is advantageous if a control unit is provided for controlling the drive, the control unit being configured such that it controls the drive depending on the sensor signal. This allows automated control of the drive for replacing the nonwoven filter region on the top of the heat exchanger element. Furthermore, it is conceivable that the control unit is designed to control the drive in a continuous mode or in a cyclical rhythm determined by an operator.

Furthermore, it has proven to be advantageous if a main housing is provided, in which the heat exchanger element is arranged, a receiving housing for receiving a receiving element being provided in each case on the main housing, on two opposite sides. The fresh roll of nonwoven filter can be inserted into one of the receiving elements in the receiving housing. The free end of the nonwoven filter can then be guided through the main housing to the other receiving element, which is located in its own receiving housing, and attached to the receiving element there. The nonwoven filter can be unwound from the roll by appropriately driving the receiving element, which takes up the free end of the nonwoven filter. Since each receiving element has its own housing, existing heat exchanger modules that do not have a nonwoven filter can be retrofitted.

In this case, it is advantageous if the drive is flanged to one of the receiving housings. The drive can be located outside the receiving housing, the drive shaft then preferably extending through the receiving housing to the receiving element which is provided inside the receiving housing.

Furthermore, it has proven advantageous if at least one of the receiving housings has an inclined side running parallel to its longitudinal axis and obliquely to the upper side of the heat exchanger element. This arrangement is comparatively space-saving and yet reliable in operation.

Preferably, the inclined side has a window so that the condition of the nonwoven filter in the respective receiving housing can be checked by visual inspection. Furthermore, the inclined side is preferably designed to be openable so that the roll or the nonwoven filter can be replaced without having to open the main housing in which the heat exchanger element is provided.

The heat exchanger element is preferably arranged so that it can be pulled out of the main housing in a drawer-like manner and thus replaced. This allows a contaminated heat exchanger element to be easily removed from the main housing without the nonwoven filter present above the heat exchanger element hindering the replacement of the heat exchanger element. The arrangement is preferably such that the removed heat exchanger element can be inserted into the main housing without colliding with the nonwoven filter.

The arrangement is also preferably such that the heat exchanger element can be pulled out of the main housing or pushed into the main housing like a drawer, parallel to the plane in which the top of the heat exchanger element lies. The object mentioned at the outset is also achieved by a soldering system, in particular by a reflow soldering system, which has a process channel in which process gas is guided, the soldering system providing a heat exchanger module according to the invention on the process channel, which can in particular be arranged removably.

Further details and advantageous embodiments of the invention can be found in the following description, on the basis of which an embodiment of the invention is described and explained in more detail.

In the drawings:

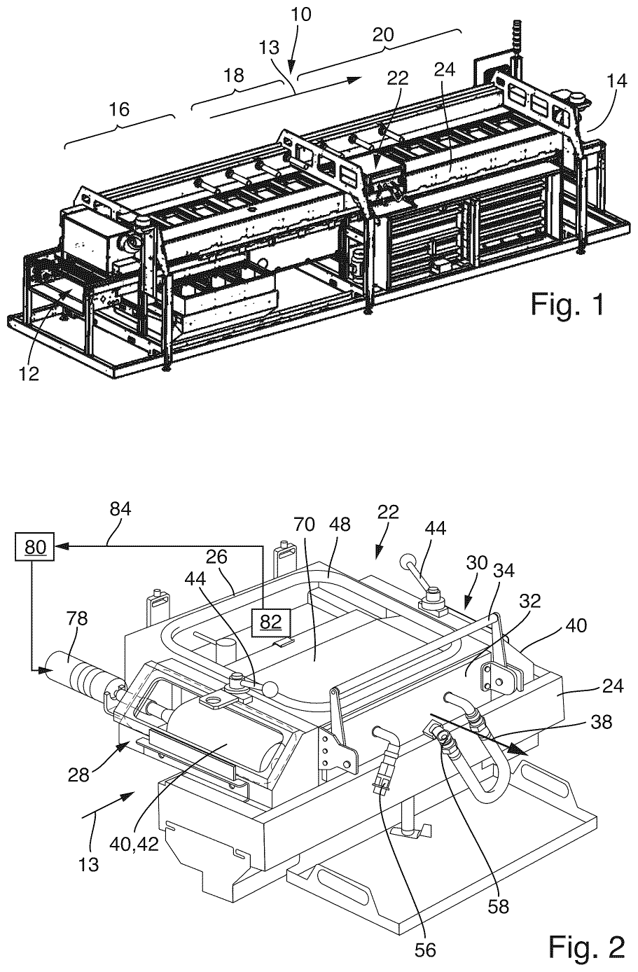

FIG. 1 is a soldering system with a heat exchanger module;

FIG. 2 is the heat exchanger module according to FIG. 1 in isolation;

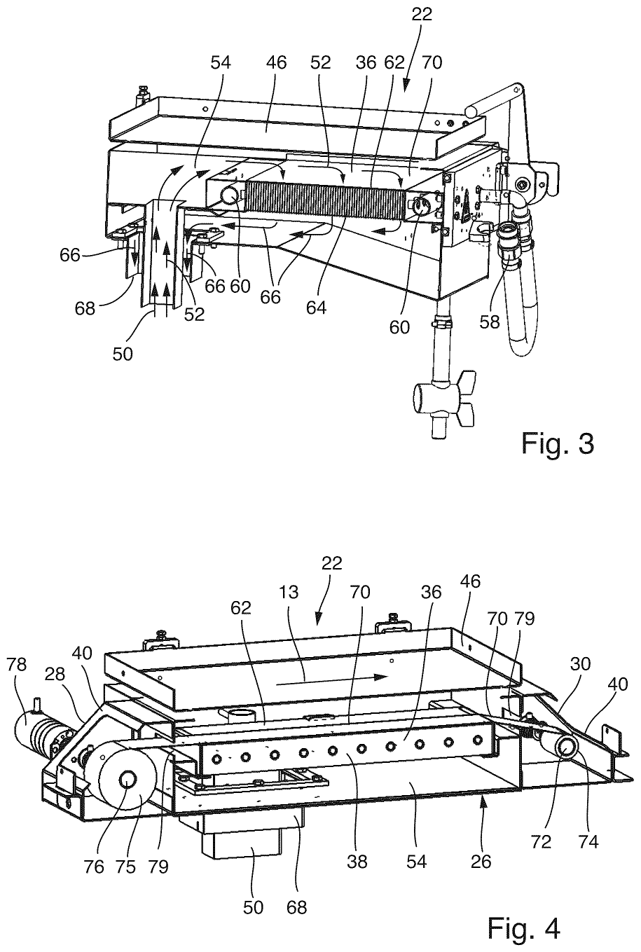

FIG. 3 is a cross section through the heat exchanger module according to FIG. 2; and

FIG. 4 is a longitudinal section through the heat exchanger module according to FIG. 1.

FIG. 1 is a reflow soldering system 10 without a cover, so that individual modules and elements of the soldering system 10 can be seen. The soldering system 10 has an input 12 through which circuit boards, which are to be soldered and are equipped with electronic components, can be introduced into the soldering system 10. The soldering system 10 has an output 14 on the side opposite the input 12, from which output soldered circuit boards can be removed. The circuit boards are transported from the input 12 along a process direction 13 to the output 14 via a transport system (not shown). The soldering system 10 has various soldering zones, in particular a preheating zone 16, a process zone 18 and a cooling zone 20. Different temperatures prevail in the different zones 16 to 18. In order to reduce the temperature in the cooling zone 20, a heat exchanger module 22 is shown by way of example in FIG. 1. According to the invention, a plurality of heat exchanger modules 22 can be provided in the cooling zone 20 or in other zones. The heat exchanger module 20 is removably arranged on a longitudinal beam 24 of the soldering system 10 that extends in the longitudinal direction. With the heat exchanger module 22, process gas can be removed from the process channel, cooled, and fed back into the process channel.

From FIG. 2, which shows the heat exchanger module 22 on the longitudinal member 24 in isolation, it is clear that the heat exchanger module 22 comprises a main housing 26 and two receiving housings 28, 30. The two receiving housings 28, 30 are in each case fastened to the main housing 26 on opposite sides of the main housing. The receiving housing 28 faces the machine input 12 and the receiving housing 30 faces the machine output 14.

The main housing 26 is essentially cuboid-shaped and has a lever 34 on its front longitudinal side 32, with which the main housing 26 can be opened and with which a heat exchanger element 36 present in the main housing 26, which can be clearly seen in FIGS. 3 and 4, can be pulled out of the main housing 26 in a drawer-like manner transversely to the process direction 13 and essentially horizontally along the arrow 38.

As is further clear from FIG. 2, the two receiving housings 28, 30 each have an inclined side 40 running parallel to their longitudinal axis (which runs transversely to the process direction 13) and obliquely to the upper side of the heat exchanger module 22. An openable window 42 is provided on the respective inclined side 40, which can be locked with a lever 44 in each case.

The top of the heat exchanger module 22 can also be opened by removing or pivoting open a cover element 46 (not shown in FIG. 2 but shown in section in FIGS. 3 and 4). In this case, the cover element 46 rests on a peripheral seal 48 which can be clearly seen in FIG. 2.

As is clear from the sections according to FIGS. 3 and 4, the heat exchanger module 22 has an inlet 50 for the inlet of process gas 52 coming from the soldering system 10. The inlet 50 opens into a transfer chamber 54 in which the heat exchanger element 38 is accommodated. The heat exchanger element 38 itself is designed so that a coolant, in particular water, can flow through it, connections 56, 58, as shown in FIG. 2, being provided for this purpose. In the section according to FIG. 3, only the connection 58 is visible. Distribution pipes 60, as shown in FIG. 3, are provided for distributing the coolant in the heat exchanger element 36. Consequently, during operation of the soldering system, the process gas 52 is passed through the inlet 50 into the transfer chamber 54. Furthermore, the process gas 52 is passed through the substantially horizontally arranged heat exchanger element 38, the process gas 52 entering the heat exchanger element 36 at the top 62 and exiting the heat exchanger element 36 at its bottom 64. The cooled process gas 66 then exits the heat exchanger module 22 via an outlet 68 provided on the heat exchanger module 22 and is fed back into the process channel.

In order to avoid contamination of the heat exchanger element 36 with particles or condensate, a nonwoven filter 70 is provided on the top 62 of the heat exchanger element 36, which is clearly visible in particular in the section according to FIG. 4.

A first receiving element 72 is provided in the receiving housing 30, on which receiving element a roll 74 with nonwoven material 70 is arranged. The nonwoven material 70 coming from the roll 74 extends over the top 62 of the heat exchanger element 36 to a second receiving element 76 present in the receiving housing 28, on which the used nonwoven material 70 leaving the transfer chamber 54 is wound up on a roll 75. In this case, the arrangement is such that the nonwoven material 70, which is present within the receiving chamber 54, at least largely completely covers the top 62 of the heat exchanger element 36 and extends to openings 79 present on the main housing 26 and the receiving housings 28, 30.

For unrolling the nonwoven material 70 from the receiving element 72 and for rolling the nonwoven material 70 onto the receiving element 76, a drive 78 is provided, which can be driven via a control unit 80 indicated in FIG. 2. In this case, the drive 78 is flanged to the receiving housing 28, the drive shaft of the drive 78 passing through the housing wall of the receiving housing 28 and being rotationally coupled to the receiving element 76.

Furthermore, a sensor unit 82 is provided, which is shown schematically in FIG. 2. The sensor unit 82 serves to generate sensor signals 84 which represent a degree of contamination or a flow resistance of the nonwoven filter 70 guided over the top 62 of the heat exchanger element 36. The sensor signals 84 are fed to the control unit 80, as indicated in FIG. 2. Depending on the sensor signals 84, the control unit 80 can then drive the drive 78. Consequently, if a high degree of contamination is detected via the sensor unit 82, the motor 78 is activated, whereby the contaminated nonwoven filter 70 is rolled up on the receiving element 76 and fresh, unused nonwoven filter 70 is rolled off the receiving element 72 until ultimately the entire top 62 of the heat exchanger element 36 is covered with fresh nonwoven filter 70.

Overall, this can ensure that a sufficiently clean nonwoven filter 70 always comes to rest on the top 62 of the heat exchanger element 36. The arrangement can be such that, during operation of the soldering system 10, the nonwoven filter is provided continuously or discontinuously, depending on the degree of contamination, with fresh filter material 70 on the top 62 of the heat exchanger element 36. As a result, the heat exchanger module 22 can be operated for a comparatively long time without failure due to deposits or contamination.

1-10. (canceled)

11. A heat exchanger module for removably arranging on a soldering system, comprising:
an inlet for admitting process gas coming from the soldering system;
a transfer chamber in which a heat exchanger element is provided, the heat exchanger element having a top onto which the process gas can flow and being configured to allow coolant flow therethrough;
an outlet for discharging process gas from the heat exchanger module into the soldering system;
a first receiving element configured to receive a roll comprising a nonwoven filter;
a second receiving element configured to receive nonwoven filter unwound from the roll, wherein the first and second receiving elements are arranged such that, when the nonwoven filter is present on both receiving elements, it is guided from the first receiving element to the second receiving element over the top of the heat exchanger element;
a main housing in which the heat exchanger element is arranged; and
a receiving housing for each of the receiving elements provided on two opposite sides of the main housing, wherein the heat exchanger element is arranged such that it can be pulled out of the main housing in a drawer-like manner and exchanged.

12. The heat exchanger module of claim 11, further comprising a drive configured to rotationally drive the first receiving element or the second receiving element.

13. The heat exchanger module of claim 11, further comprising a sensor unit configured to provide a sensor signal representing a degree of contamination and/or a flow resistance of the nonwoven filter guided over the top of the heat exchanger element.

14. The heat exchanger module of claim 13, further comprising a control unit configured to control a drive in response to the sensor signal provided by the sensor unit.

15. The heat exchanger module of claim 12, wherein the drive is flanged to one of the receiving housings.

16. The heat exchanger module of claim 11, wherein at least one of the receiving housings has an inclined side running parallel to its longitudinal axis and obliquely to the top of the heat exchanger element.

17. The heat exchanger module of claim 16, wherein the inclined side includes a window and/or is configured to be openable.

18. A soldering system comprising a process channel carrying process gas and comprising a heat exchanger module removably arranged on the process channel, wherein the heat exchanger module is configured in accordance with claim 11.
